(19) United States
(12) Patent Application Publication
(10) Pub. No.: US 2014/0088879 A1
(43) Pub. Date: Mar. 27, 2014

(54) SYSTEM AND METHOD FOR NOISE ATTENUATION IN SEISMIC DATA

(71) Applicants: Gilles Hennenfent, San Ramon, CA (US); Karl Boles, Richmond, TX (US); Yves Dansereau, Calgary (CA)

(72) Inventors: Gilles Hennenfent, San Ramon, CA (US); Karl Boles, Richmond, TX (US); Yves Dansereau, Calgary (CA)

(73) Assignee: Chevron U.S.A. Inc., San Ramon, CA (US)

(21) Appl. No.: 13/628,273

(22) Filed: Sep. 27, 2012

(51) Int. Cl. G01V 1/28; G06F 19/00

(52) U.S. Cl. 702/17; 702/14

(57) ABSTRACT

A system and method for processing a prestack seismic dataset with at least one smoothly varying (redundant) axis including transposing the prestack seismic dataset, slicing the prestack seismic dataset into depth or time slices with at least one redundant axis, processing the slices, and transposing the slices to create a processed seismic dataset. The redundant axis may be representative of offset, angle, azimuth, or time between time-lapse surveys. The processing may include filtering the slices to attenuate coherent or incoherent noise.

### FIELD OF THE INVENTION

The present invention relates generally to methods and systems for processing seismic data and, in particular, methods and systems for attenuating coherent and incoherent noise in seismic data.

### BACKGROUND OF THE INVENTION

Exploration and development of hydrocarbon reservoirs may be efficiently done with the help of seismic data which must be properly processed in order to allow interpretation of subsurface features. The seismic data may be obtained by activating seismic sources that create seismic energy which propagates through the subsurface and is recorded by an array of seismic receivers. In practice, seismic data is often contaminated by noise which may be caused by kinematics at the time of acquisition, such as multiple reflection energy being recorded, or by flaws in the processing techniques used, such as imaging artifacts.

Efficient and effective methods for attenuating noise in seismic data are needed to improve the final seismic image and allow proper interpretation of the subsurface features.

### SUMMARY OF THE INVENTION

Described herein are implementations of various approaches for a computer-implemented method for subsurface characterization from seismic data.

In one embodiment, a method for processing seismic data is disclosed. The method includes receiving a prestack seismic dataset arranged with a first axis representative of time or depth, at least one redundant axis representative of a smoothly varying space such as offset or angle, and at least one other axis; transposing the prestack seismic dataset such that the first axis becomes the redundant or other axis; slicing the transposed seismic dataset to generate a plurality of time or depth slices wherein the slices have at least one redundant axis and at least one other axis; processing the plurality of slices to generate a plurality of processed slices; and transposing the plurality of processed slices to generate a processed prestack seismic dataset arranged with the first axis becoming representative of time or depth.

In another embodiment, the redundant axis may represent azimuth or the time between two or more time-lapse seismic surveys.

In a further embodiment, the processing performed on the slices may be 2D, 2.5 D, 3D or N-D filtering. The filtering may be designed to attenuate noise.

A further embodiment may include a system to perform the method. The system may include a data storage device, a processor configured to execute computer modules that are designed to perform the steps of the method, and a user interface.

Yet another embodiment may include an article of manufacture including a computer readable medium having computer readable code on it, the computer readable code being configured to implement the method.

The above summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

These and other features of the present invention will become better understood with regard to the following description, claims and accompanying drawings where:

FIG. 1 is a diagram of a 2-D seismic survey;

FIG. 2 is a diagram of a 3-D seismic survey;

FIG. 3 is a flowchart illustrating a method in accordance with the present invention;

FIGS. 4A and 4B are diagrams illustrating an exemplary seismic dataset being transformed in accordance with an embodiment of the present invention;

FIG. 5 illustrates a seismic data section before and after using an embodiment of the present invention;

FIG. 6 illustrates a seismic depth slice before and after using an embodiment of the present invention and the difference between the slices; and

FIG. 7 schematically illustrates a system for performing a method in accordance with an embodiment of the invention.

### DETAILED DESCRIPTION OF THE INVENTION

The present invention may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present invention may be coded in different languages for application in a variety of computing platforms and environments. It will be appreciated that the scope and underlying principles of the present invention are not limited to any particular computer software technology.

Moreover, those skilled in the art will appreciate that the present invention may be practiced using any one or combination of hardware and software configurations, including but not limited to a system having single and/or multiple processor computers, hand-held devices, programmable consumer electronics, mini-computers, mainframe computers, and the like. The invention may also be practiced in distributed computing environments where tasks are performed by servers or other processing devices that are linked through a one or more data communications network. In a distributed computing environment, program modules may be located in both local and remote computer storage media including memory storage devices. The present invention may also be practiced as part of a down-hole sensor or measuring device or as part of a laboratory measuring device.

Also, an article of manufacture for use with a computer processor, such as a CD, pre-recorded disk or other equivalent devices, may include a computer program storage medium and program means recorded thereon for directing the computer processor to facilitate the implementation and practice of the present invention. Such devices and articles of manufacture also fall within the spirit and scope of the present invention.

Referring now to the drawings, embodiments of the present invention will be described. The invention can be implemented in numerous ways, including, for example, as a system (including a computer processing system), a method (including a computer implemented method), an apparatus, a computer readable medium, a computer program product, a graphical user interface, a web portal, or a data structure tangibly fixed in a computer readable memory. Several embodiments of the present invention are discussed below. The appended drawings illustrate only typical embodiments of the present invention and therefore are not to be considered limiting of its scope and breadth.

The present invention relates to attenuating noise caused by imaging artifacts and/or multiple reflection energy in seismic data. The seismic data described herein is seismic data obtained by recording seismic energy transmitted from an active seismic source (e.g. Vibroseis, airguns, explosives) through a subsurface volume of interest to a seismic receiver. A seismic survey may include a plurality of seismic sources, fired simultaneously and/or sequentially, and a plurality of seismic receivers. After being recorded, the seismic data may be subjected to any number of processing steps including, for example, normal moveout correction or prestack migration. These processing steps are not intended to be limiting; one skilled in the art will recognize that there are many seismic data processing options that may be used prior to applying an embodiment of the present invention.

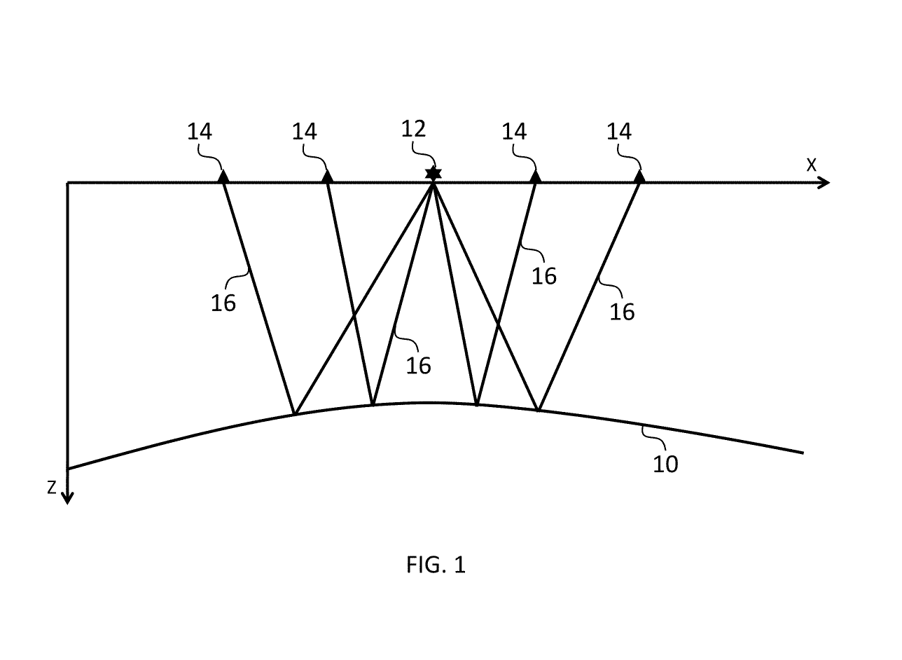

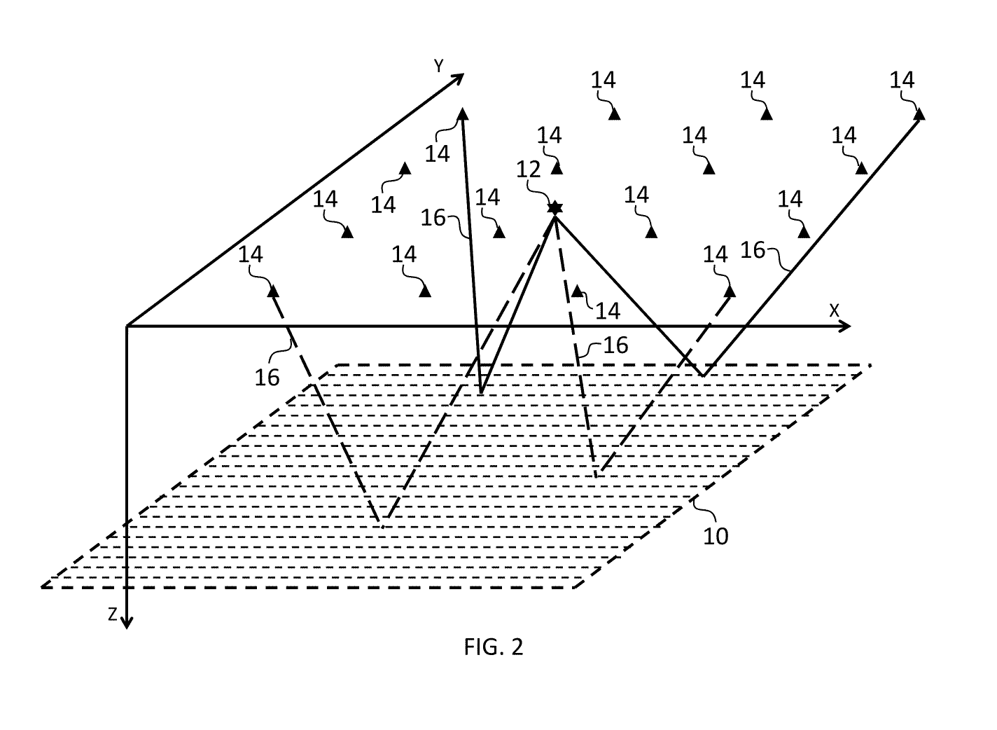

FIG. 1 illustrates a simple 2D seismic survey with a single shot 12 and four receivers 14. The shot 12 generates seismic waves that are represented here by rays 16 that reflect from a surface 10 and return to the receivers 14. FIG. 2 illustrates a simple 3D seismic survey, also with shot 12, receivers 14, and reflecting surface 10. In this case, only 4 of the rays 16 have been shown to simplify the diagram but one skilled in the art will recognize that all of the receivers will record energy from the shot. In both of these surveys, the recorded data can be indexed by a geographic location (e.g. common midpoint (CMP), inline position, crossline position) and a relative location indicating the relationship of the receiver to the shot (e.g. offset, azimuth). The geographic location can also be termed a geographic axis. There may also be multiple geographic axes (e.g. CMP_X, CMP_Y). The relative location can be termed a relative axis and may also have multiple dimensions (e.g. offset_x, offset_y). These examples are not meant to limiting; both the geographic and relative locations can be N-dimensional and therefore have N axes.

When the seismic data is processed by an algorithm that corrects for the differences in traveltime between receivers, seismic energy from a reflecting surface will occur at the same time or depth on each trace along the relative axes. In essence, the seismic events become flat along the relative axes, so that amplitude variations along a particular event are smooth. The smoothly varying nature of the events makes the data along that axis redundant. For the purposes of this paper, the relative axis is termed a redundant axis.

In addition to the relative axes described above, it is also possible that the redundant axis might represent data from two or more time-lapse datasets. In this instance, the redundant axis would indicate the difference in time between surveys.

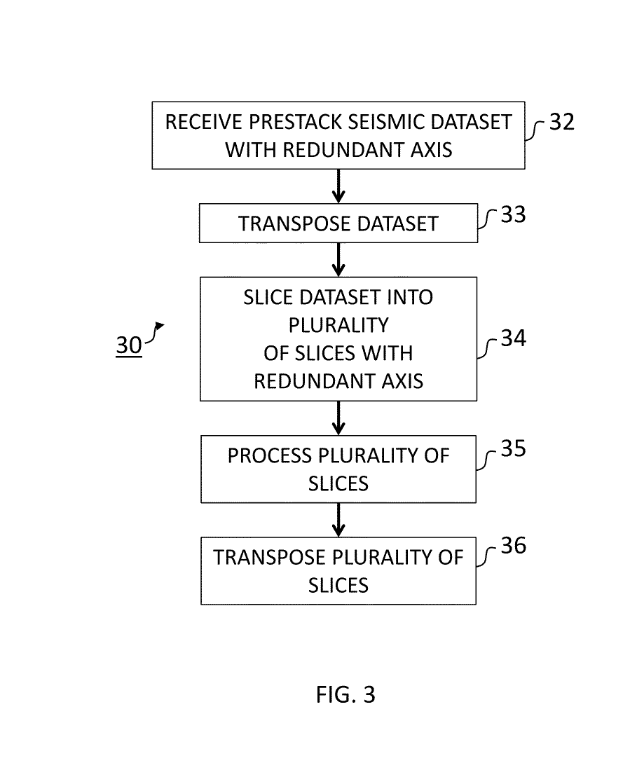

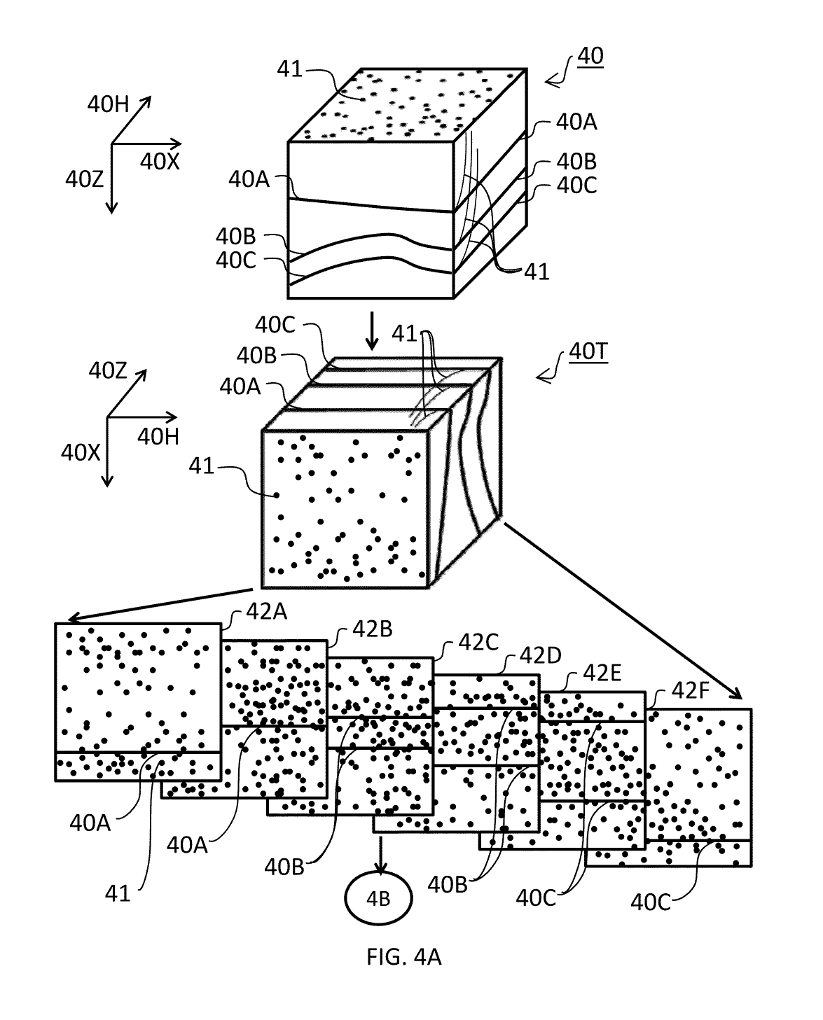

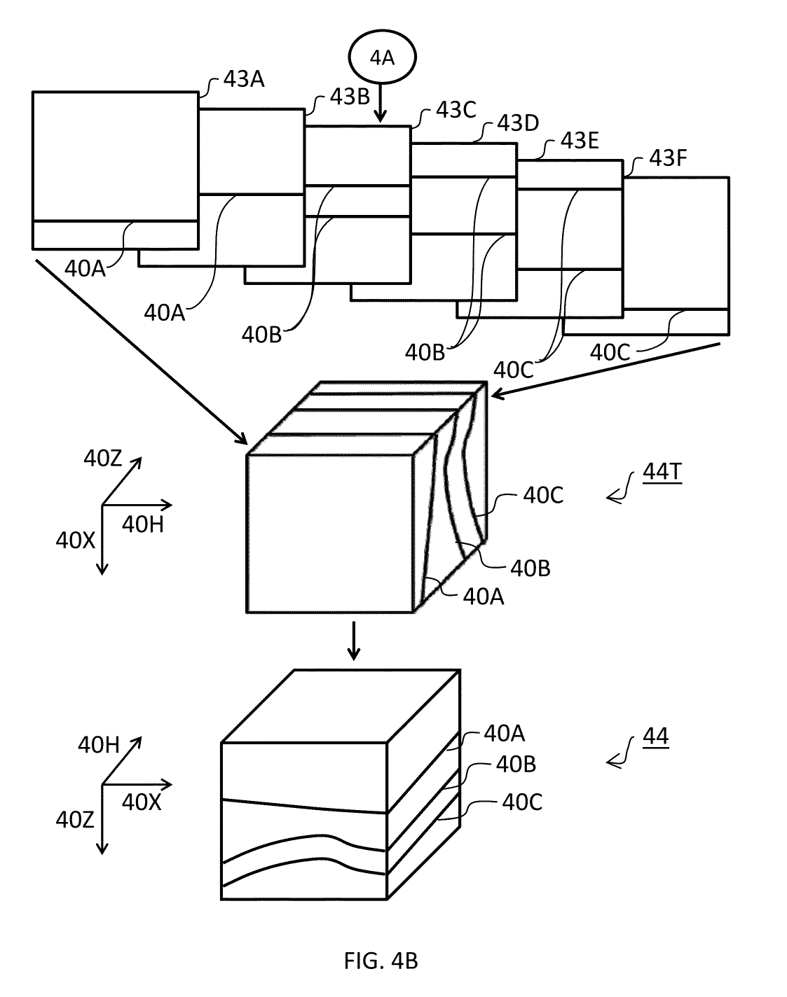

FIG. 3 shows a flowchart of an embodiment of the present invention. The method 30 is also illustrated by the diagrams of seismic data in FIGS. 4A and 4B. The prestack seismic dataset received at operation 32 may appear similar to the seismic data volume 40. The prestack seismic dataset has at least one redundant axis. In FIG. 4A, the axes of the seismic data volume are oriented as indicated by the directional arrows located to the left of the data volumes. These directional arrows are 40X which shows the geographic axis, 40H which shows the redundant axis, and 40Z which indicates the depth or time axis. For seismic data volume 40, the time or depth axis 40Z is also commonly referred to as the vertical or first axis. Seismic data volume 40 has three events (reflecting surfaces) 40A, 40B, and 40C. Along the geographic axis 40X, event 40A is a dipping reflector and events 40B and 40C are asymmetrical anticlines. Along the redundant axis 40H, all three events 40A, 40B, and 40C are flat. The seismic data volume 40 also contains noise 41, shown as swooping lines in the 40Z-40H plane and dots in the 40X-40H plane. This noise is a simple example and is not meant to be limiting. One skilled in the art will appreciate that there are many types of coherent and incoherent noise that may contaminate seismic data.

At operation 33 of method 30, the prestack seismic dataset is transposed. The transposition transforms the arrangement of the seismic data volume so that the time or depth axis is no longer the first axis. FIG. 4A shows the transposed seismic dataset 40T with a new set of directional arrows for 40X, 40H, and 40Z. In this example, the first axis is now 40X, the geographic axis. It could also be the redundant axis 40H. The events 40A, 40B, and 40C are labeled as is the noise 41.

After the prestack seismic dataset has been transposed to create a transposed seismic dataset, the transposed seismic dataset is sliced into time or depth slices at operation 34. Each of these slices has at least one redundant axis. In FIG. 4A, the transposed seismic dataset 40T has been sliced into slices 42A-F. Each of these slices has a geographic axis 40X (vertical axis) and a redundant axis 40H (horizontal axis). It is not necessary for the slices to have a geographic axis; it is possible that the seismic data volume might have multiple redundant axes so the slices could have redundant axes. Although the term “slice” implies a plane with two dimensions, this is not meant to be limiting. The slices of the present invention are time or depth slice, meaning that they represent a single time or depth sample, but they could have multiple geographic or redundant axes and so may be N-dimensional. Only six slices are shown here but in practice there could be separate slices for each sample along the time or depth axis. These slices show noise 41 as dots. They also show the flat events along axis 40H that appear when events 40A, 40B, and 40C are sliced through. The flat events in slices 42A-F are labeled to correspond to the event of which they are a part. Although the noise 41 in slices 42A-F is incoherent, this is not meant to be limiting. The method is also applicable to data which shows as coherent noise in the slices.

Referring again to FIG. 3, operation 35 performs a processing step on the slices. In the example of FIG. 4A, this processing is designed to attenuate the noise 41 seen in seismic data volumes 40, 40T and slices 42A-F. The processing may be a algorithm such as a median filter, low-pass filter, high-pass filter, bandpass filter, trace mixing, wavelet transform filtering, truncated SVD filtering or curvelet domain filtering. These examples are not meant to be limiting; one skilled in the art will recognize that there are many possible processing algorithms that might be applied to the slices to improve continuity of the events 40A, 40B, and 40C and/or attenuate the noise 41.

Further, although operations 34 and 35 are shown sequentially in FIG. 3, these operations need not be done serially. It is possible to extract slices at operation 34 that are processed at operation 35 while other slices are being extracted. It is also possible that the processing done at operation 35 may be done on several slices at once rather than on each slice individually. In this case, the processing algorithm may act across the time or depth dimension. Further, since the slices may be N-dimensional with multiple redundant and/or geographic axes, the processing may be N-dimensional.

For the example of FIG. 4A and 4B, the operation 35 filters the noise 41 out of the slices 42A-F of FIG. 4A to generate the clean slices 43A-F of FIG. 4B. The flat events 40A, 40B and 40C are indicated in slices 43A-F. Together these slices make up the processed transposed dataset 44T. The processed transposed dataset 44T has its axes indicated by directional arrows 40X, 40H, and 40Z. For this dataset, the first axis is the geographic axis 40X.

The next step of method 30 of FIG. 3 is operation 36, transposing the processed slices. FIG. 4B shows the processed dataset 44 which now has a first axis that is the depth or time axis 40Z, as indicated by the directional arrow. The other axes are the geographic axis 40X and the redundant axis 40H.

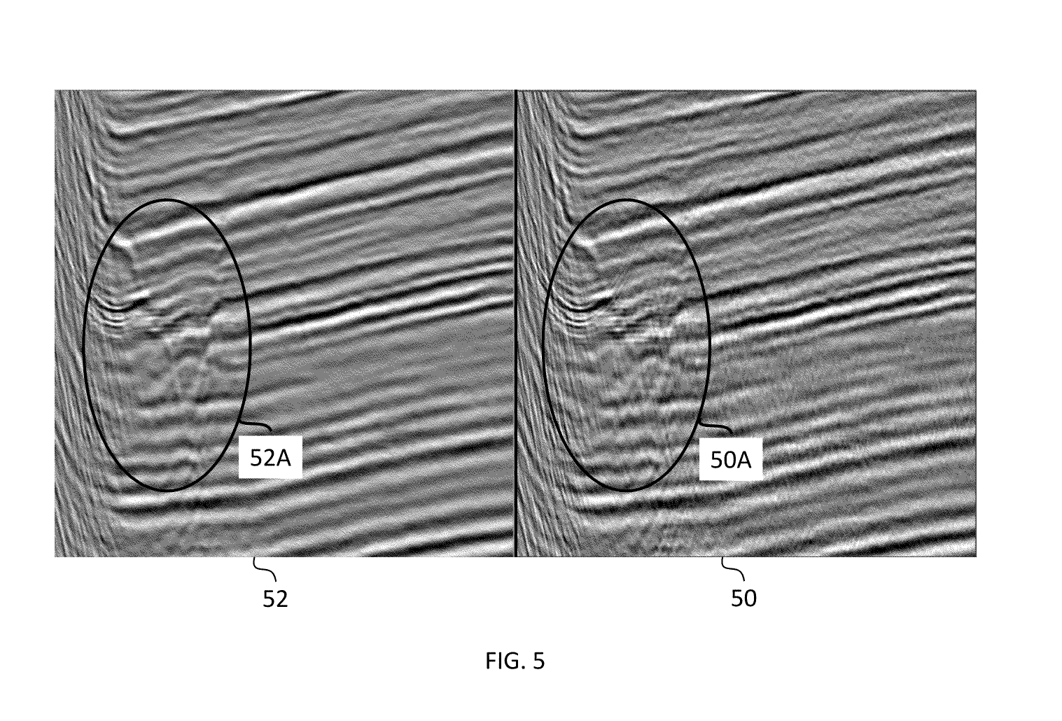

The result of an embodiment of the present invention may be seen in FIG. 5. On the right there is a seismic data section 50 from before the method 30 of FIG. 3. Seismic data section 50 is noisy, contaminated by migration artifacts, particularly in oval 50A. On the left there is a seismic data section 52 from after the method 30, using curvelet filtering. Seismic data section 52 is cleaner than seismic data section 50, particularly in oval 52A where the migration artifacts have been largely attenuated without negatively impacting the faults.

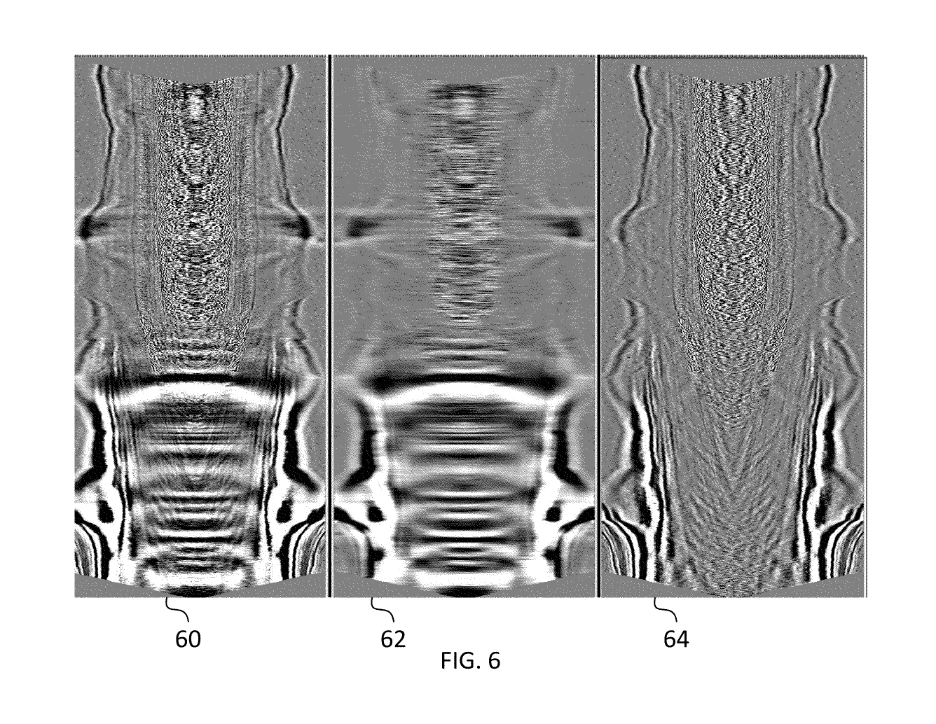

FIG. 6 shows another result from an embodiment of the present invention. Here, the input data 60 is a depth slice with the horizontal axis being offset and the vertical axis being common depth point (CDP). It is quite noisy. The result of an embodiment of the invention is seen in output data 62, which is considerably cleaner. In this example, the processing performed on the depth slices was an alpha trim trace mix. The difference between the input data 60 and the output data 62 is seen in difference 64.

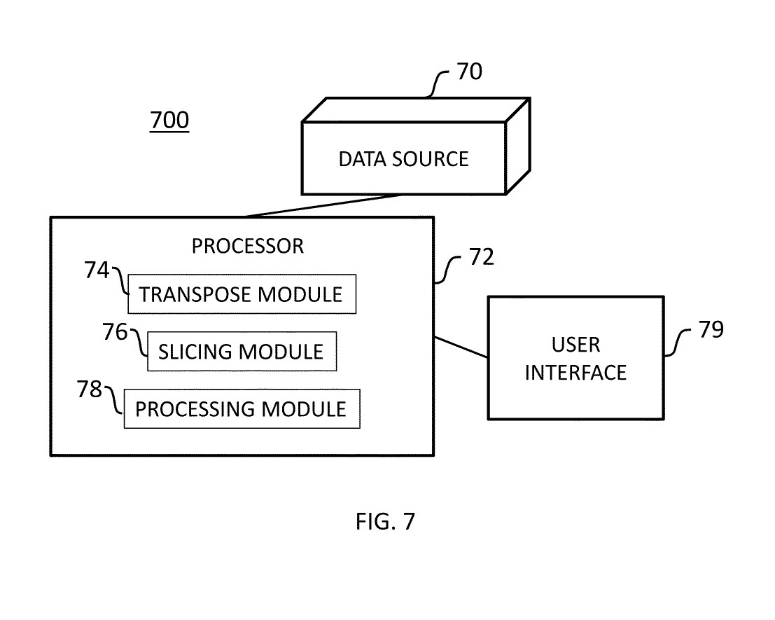

FIG. 7 is a schematic diagram of a system 700 for performing the method 30. The system includes a data source 70 which contains a prestack seismic dataset. The data source may be, for example, a computer hard drive. The data source 70 is in communication with a computer processor 72. The computer processor 72 may be a single processor, multiple processors, and/or a distributed computing system wherein multiple processors are on multiple computers. The computer processor 72 is configured to execute computer-readable instructions from computer modules. The transpose module 74 is designed to transpose the prestack seismic dataset as described in FIG. 3 method 30 operations 33 and 36. The slicing module 76 is designed to perform operation 34 and the processing module 78 performs operation 35. The computer processor 72 is also in communication with a user interface 79. The user interface 79 may include a display and a user input device such as a keyboard and mouse. The user interface allows the user to see the input, intermediate and output products of embodiments of the present invention and to provide information to the computer processor 72 in order to execute the computer modules. The system 700 is not meant to be limiting; other components may be useful including other computer modules.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention. In addition, it should be appreciated that structural features or method steps shown or described in any one embodiment herein can be used in other embodiments as well.

What is claimed is:

1) A computer-implemented method for processing seismic data, the method comprising:
a. receiving, at a computer processor, a prestack seismic dataset arranged with a first axis representative of either time or depth, at least one redundant axis representative of a first smoothly varying space, and at least one other axis representative of either a second smoothly varying space or a geographic space;
b. transposing, via the computer processor, the prestack seismic dataset such that the first axis becomes representative of the geographic space or either the first or second smoothly varying space to generate a transposed seismic dataset;
c. slicing, via the computer processor, the transposed seismic dataset to generate a plurality of slices representing individual instances of either time or depth, wherein the slices have the at least one redundant axis and the at least one other axis;
d. processing, via the computer processor, the plurality of slices to generate a plurality of processed slices; and
e. transposing, via the computer processor, the plurality of processed slices to generate a processed prestack seismic dataset arranged with the first axis becoming representative of either time or depth, the at least one redundant axis, and the at least one other axis.

2) The method of claim 1 wherein the first smoothly varying space is one of offset, angle, azimuth, or time between time-lapse seismic surveys.

3) The method of claim 1 wherein the second smoothly varying space is one of offset, angle, azimuth or time between time-lapse seismic surveys.

4) The method of claim 2 wherein the geographic space is one of inline position, crossline position, common midpoint position, common depth point position, common reflection point position, or UTM position.

5) The method of claim 1 wherein the processing is 2D filtering of the slices.

6) The method of claim 5 wherein the 2D filtering is designed to attenuate noise.

7) The method of claim 1 wherein the processing is performed on each slice individually.

8) The method of claim 1 wherein the processing is performed on at least two slices simultaneously.

9) The method of claim 8 wherein the processing is 3D filtering.

10) The method of claim 1 wherein the prestack seismic data has been preprocessed such that at least one set of seismic events is substantially flat along the at least one redundant axis.

11) The method of claim 1 wherein the at least one redundant axis is one unit in length.

12) The method of claim 1 wherein the at least one other axis is one unit in length.

13) The method of claim 1 wherein the prestack seismic dataset is arranged with at least two redundant axes. The method of claim 13 wherein the processing is an N-dimensional filter.

14) The method of claim 1 wherein the prestack seismic dataset is arranged with at least two other axes.

15) The method of claim 15 wherein the processing is an N-dimensional filter.

16) A system for processing a prestack seismic dataset, the system comprising:
a. a data source containing the prestack seismic dataset arranged with a first axis representative of either time or depth, at least one redundant axis representative of a first smoothly varying space, and at least one other axis representative of either a second smoothly varying space or a geographic space;
b. at least one computer processor being configured to communicate with the data source and to execute computer program modules, the computer modules comprising:
i. a transpose module for transposing the prestack seismic dataset to generate a transposed seismic dataset;
ii. a slicing module for creating slices representative of individual instances of either time or depth from the transposed seismic dataset; and
iii. a processing module for processing the slices; and
c. a user interface.

17) An article of manufacture including a computer readable medium having computer readable code on it, the computer readable code being configured to implement a method for processing a prestack seismic dataset arranged with a first axis representative of time or depth, at least one redundant axis representative of a first smoothly varying space, and at least one other axis representative of a second smoothly varying space or a geographic space, the method comprising:
a. transposing the prestack seismic dataset such that the first axis becomes representative of the geographic space or the first or second smoothly varying space to generate a transposed seismic dataset;
b. slicing the transposed seismic dataset to generate a plurality of slices representative of individual instances of either time or depth wherein the slices have the at least one redundant axis and the at least one other axis;
c. processing, via the computer processor, the plurality of slices to generate a plurality of processed slices; and
d. transposing, via the computer processor, the plurality of processed slices to generate a processed prestack seismic dataset arranged with the first axis becoming representative of time or depth, the at least one redundant axis, and the at least one other axis.
